(19) United States
(12) Patent Application Publication
(10) Pub. No.: US 2009/0164121 A1
(43) Pub. Date: Jun. 25, 2009

(54) MANY-TO-MANY CROSSLINK COMMUNICATION POSITIONING APPARATUS

(76) Inventors: Po-Ju CHEN, Taipei (TW); Wen-Hung Hsu, Taipei (TW); Hsin-Hsin Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/047,407

(22) Filed: Mar. 13, 2008

(30) Foreign Application Priority Data
Dec. 21, 2007 (TW) 096221858

(51) Int. Cl. G01C 21/00

(52) U.S. Cl. 701/213

(57) ABSTRACT

A many-to-many crosslink communication positioning apparatus includes a CPU, a RF circuit, a GPS circuit, an electronic compass circuit and a display device. Several devices are searched for their serial numbers at the same time, and the serial numbers are compared. The device with a large serial number is a master, and the device with a small serial number is a slave. Data including the search mode, call mode, frequency hopping mode, transmission power adjusting mode and correction time mode of the master and the slave are linked, and then related position and distance of the master and the slave are displayed on a screen of the communication positioning apparatus.

### BACKGROUND OF THE INVENTION

1. Field of the Invention

The present invention generally relates to a positioning apparatus, and more particularly to a many-to-many crosslink communication positioning apparatus.

2. Description of Prior Art

Taking trips or climbing mountains has become one of the best leisure activities, and thus families, friends, and companies love to get together for outdoor activities during weekends or holidays. As economy and technology advance, cars are primarily used as transportation means for outdoor activities, and usually many cars are teamed up to form a car team for the activity.

In general, when a car team sets off, each car of the team is equipped with a walkie-talkie or a mobile phone for communications to prevent any car from leaving behind or getting lost, or a satellite navigation system is provided for guiding the cars to the destination. Although walkie-talkies and mobile phones can be used for the coordination among cars, each driver has to watch the rear mirror from time to time and make sure that each car follows closely. If any car is left behind, the car in the front is informed to pull aside of the road and wait for the coming car, or the car left behind is noticed by walkie-talkies. However, such arrangement is very inconvenient, and may even cause accidents easily. Even though the car left behind can be guided to the destination by the satellite navigation system, the satellite navigation system used in a car usually allows users to locate their own position, but not the positions of other cars or the distance of their car away from the team.

In addition, disasters in mountain usually occur when a mountain climber gets loss in an unfamiliar mountain path or injured. For disasters in mountain, mountain climbers are unable to inform rescuers immediately or tell their exact location to the rescuers, and they have to wait for rangers to find them after they have not returned at the specific time, and then the rescue team is informed. During a rescue, the rescuers have problems of locating the mountain climbers who are in danger, and the rescuers have to search the whole mountain which takes up much time and delays the time of rescuing the mountain climbers.

### SUMMARY OF THE INVENTION

It is a primary objective of the present invention to provide a novel communication positioning apparatus, wherein several same communication positioning apparatuses are combined by a cross allocation, and one of the positioning apparatuses is a master, and the remaining ones are slaves. During its application, both of the master and the slave can show their positions as well as the positions of others. In the meantime, the communication positioning apparatus can transmit an emergency rescue signal to all users who hold the same kind of communication positioning apparatuses to inform them about the signal transmitting position.

To achieve the foregoing objective, the present invention provides a many-to-many crosslink communication positioning apparatus, and the communication positioning apparatus comprises: a CPU, a RF circuit, a GPS circuit, an electronic compass circuit and a display device. The CPU further comprises: a CPU kernel, a RF control unit, a GPS control unit, an electronic compass control unit, a transmission power modulating unit, a frequency hopping unit, a timer, a random number generator, a schedule processing unit, a data processing unit, a function processing unit and a communication interface unit. A plurality of same apparatuses is used for searching a plurality of serial numbers and comparing the serial numbers. The device with a large serial number (ID) is the master, and the device with a small serial number (ID) is a slave. The master and the slave perform a data link for a search mode, a call mode, a frequency hopping mode, a power transmission adjusting mode and a correction time mode. After the data are linked, related positions and distance of the master and slaves are displayed simultaneously on a map displayed by the communication positioning apparatus.

### BRIEF DESCRIPTION OF DRAWINGS

FIG. 1 is a schematic block diagram of a communication positioning apparatus in accordance with the present invention; and

FIG. 2 is a schematic block diagram of an internal circuit of a CPU in accordance with the present invention.

### DETAILED DESCRIPTION OF THE INVENTION

The technical characteristics, features and advantages of the present invention will become apparent in the following detailed description of the preferred embodiments with reference to the accompanying drawings. The drawings are provided for reference and illustration only, but not intended for limiting the present invention.

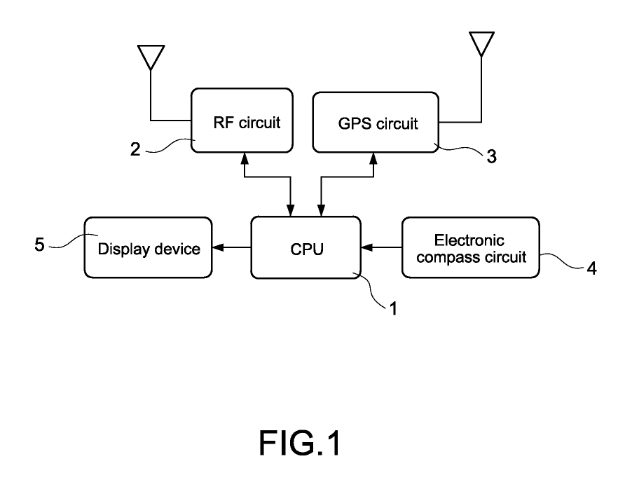

Referring to FIG. 1 for schematic block diagram of a communication positioning apparatus in accordance with the present invention, the communication positioning apparatus comprises: a central processing unit (CPU) 1, a radio frequency circuit (RF circuit) 2, a global positioning system (GPS) circuit 3, an electronic compass circuit 4 and a display device 5.

The CPU 1 is provided for controlling an external circuit and an internal operation, and executing an external instruction.

The RF circuit 2 is electrically coupled to the CPU 1 for transmitting a signal outputted by the CPU 1 to another communication positioning apparatus, or receiving a signal transmitted by another communication positioning apparatus.

The GPS circuit 3 is electrically coupled to the CPU 1 for receiving a coordinate position signal transmitted by a satellite into the CPU 1.

The electronic compass circuit 4 is electrically coupled to the CPU 1 for providing angle information of an electronic compass and a geomagnetic north pole or a geomagnetic south pole to the CPU 1.

The display device 5 is electrically coupled to the CPU 1 and driven by the CPU 1 for displaying the linked information and the positions of several communication positioning apparatuses.

The several communication positioning apparatuses perform a many-to-may crosslink communication positioning allocation, and the circuits and programs of each communication positioning apparatus are the same, and thus only one of the apparatuses needs to be set as a master by the crosslink positioning communication method, and the remaining ones are slaves.

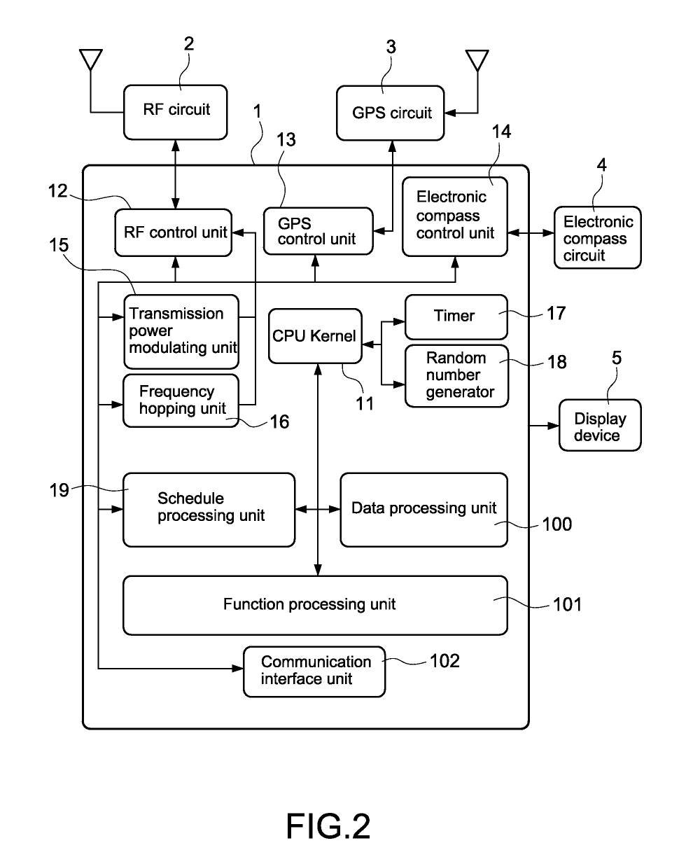

Referring to FIG. 2 for a schematic block diagram of an internal circuit of a CPU in accordance with the present invention, the CPU 1 comprises a CPU kernel 11, a RF control unit 12, a GPS control unit 13, an electronic compass control unit 14, a transmission power modulating unit 15, a frequency hopping unit 16, a timer 17, a random number generator 18, a schedule processing unit 19, a data processing unit 100, a function processing unit 101 and a communication interface unit 102.

The CPU kernel 11 is provided for processing an arithmetic operation and executing and processing a program.

The RF control unit 12 is electrically coupled to the RF circuit 2 for controlling the signal transmission and signal receiving of the RF circuit 2.

The GPS control unit 13 is electrically coupled to the GPS circuit 3 for controlling the GPS circuit 3 to receive a satellite signal and positioning information.

The electronic compass control unit 14 is electrically coupled to the electronic compass circuit 4 for controlling the electronic compass circuit.

The transmission power modulating unit 15 is electrically coupled to the RF control unit 12 for modulating the transmission power according to the distance between the apparatuses (master and slave).

The frequency hopping unit 16 is electrically coupled to the RF control unit 12 for performing a frequency hopping when the received or transmitted data is interfered or the CPU 1 calculates that a frequency hopping is needed.

The timer 17 is electrically coupled to the CPU kernel 11 for generating timing for the whole system, and all functions of the apparatuses use the timing generated by the timer as a basis.

The random number generator 18 is electrically coupled to the CPU kernel 11 for generating a random number for the use by the CPU 1.

The schedule processing unit 19 is electrically coupled to the CPU kernel 11, the data processing unit 100, the function processing unit 101, the RF control unit 12, GPS control unit 13, the electronic compass control unit 14, the transmission power modulating unit 15, the frequency hopping unit 16, and an external communication interface 102 for processing an electronic compass control schedule processing, a GPS control schedule processing, a RF control schedule processing and an external communication schedule processing in each time slot.

The data processing unit 100 is electrically coupled to the CPU kernel 11, the schedule processing unit 19 and the function processing unit 101 for processing an electronic compass data, a GPS signal, a RF signal and an external instruction data.

The function processing unit 101 is electrically coupled to the CPU kernel 11, the schedule processing unit 19 and the data processing unit 100 for computing and processing a data link function, a search function, a call function, an emergency call function, a search emergency call function and a pairing function, etc.

The external communication interface unit 102 is electrically coupled to the schedule processing unit 19 for receiving an instruction and a reply (such as pairing, linking, data report and emergency call, etc) outputted by an external hardware, and providing an electronic compass to the CPU kernel according to a different required GPS signal on a different apparatus.

When several communication positioning apparatuses are allocated for a many-to-many crosslink communication positioning in accordance with the present invention, one of the communication positioning apparatuses is a master and the remaining ones are slaves after the communication positioning apparatuses are linked. For simplicity, the invention is illustrated by two or three communication positioning apparatuses only.

When a first apparatus and a second apparatus perform a search, a search slave data is transmitted, and the schedule processing unit 19 controls the RF control unit 12 at an appropriate time to search for a transmission and receiving by the search function of the function processing unit 101. When the first apparatus (with a serial number 001) receives a signal from the second apparatus (with a serial number 002), the two serial numbers (IDs) are compared, the serial number (ID) of the second apparatus is larger than that of the first apparatus, and thus the first apparatus is a slave, and the second apparatus is a master (wherein the method of comparing the IDs is changed to setting the small ID for the master according to different systems). When the master is ready to receive a signal from the slave, the master sends a signal to the slave first, and the slave replies a signal to the master. After the master receives a reply signal, the master will send an acknowledge signal to complete linking the slave.

When the master is not at a time slot, the search jumps and looks for an apparatus. If the slave is not at a time slot, the slave jumps to search whether or not there is a new apparatus. If there is a third apparatus with a serial number 003 connected, the ID of each apparatus is compared, and the apparatus with the highest ID is a master. Thus, the first apparatus is a slave, and the second apparatus is a slave, and the second apparatus is a master.

If the third apparatus is a master, the reply signal of the slave is received. If there is a reply signal from the slave is received, then the master will send an acknowledge signal to the slave to complete the process.

When the master performs a search, a random number generator 18 is used for generating a time slot in the search channel, and sends out a search slave signal through the search function of the function processing unit 10 and the external communication interface unit 102 to search a missing slave. Upon the receipt of a reply signal from the slave, the master replies the received signal to the slave. After the slave has receives the search slave signal from the master, the slave sends the reply signal to the master to confirm the signal transmitted by the master, so as to complete the search mode.

When the slave calls the master, the RF control unit 12 is controlled by the search function of the function processing unit 101 and passed to the schedule processing unit 19 to send a master calling signal to the master at an appropriate time. When the master receives the master calling signal from the slave, the relative distance between the master and the slave and their positions are calculated and a signal is replied to the slave to complete calling the master and slave.

If the index of intensity of the signal received by the master is too small or the stat loss in the same time slot is too large, the frequency hopping unit 16 will jump into a frequency hopping mode, and control the RF control unit 12 through the function processing unit 102 by the schedule processing unit 19 at an appropriate time to start searching whether or not there is an available channel in all channels transmitted by the master. If there is a channel available, the frequency channel hopping signal transmitted by the RF control unit 12 and the RF circuit 2 is sent to notice all slaves for hopping their frequency, and the slaves will start hopping the frequency.

The master receives data from the slave, and calculates the longitudes and latitudes and the index of intensity of the received signals, and also determines whether or not it is necessary to adjust the transmission power of the slave. If the transmission power of the slave is adjusted, the transmission power modulating unit 15 transmits a power adjusting signal through the RF control unit 12 and the RF circuit 2 to the slave for adjusting the transmission power. After the slave has received the transmission power adjusting signal transmitted from the master, the slave will adjust the transmission power of the master according to the transmission power of the slave.

During a master emergency call, the master enters into an emergency call mode through the function processing unit 102, and now all using functions are disabled. The schedule processing unit 19 adjusting the transmission of the emergency call signal according to the level of power of a battery. The emergency call mode is completed after the emergency call mode is disabled, and all functions are enabled. During a slave emergency call, all using functions are disabled similarly, and the schedule processing unit 19 adjusting the transmission of the emergency call signal according to the level of power of a battery. After the emergency call mode is disabled, the emergency call mode is completed, and all functions are enabled.

When the master is at a normal mode, the function processing unit 101 can search whether or not there is an emergency call. When the master is turned on, the master enters into an emergency call mode. If the master is not at a time slot in a working mode, an emergency call is received from an emergency call channel. After it is determined that an emergency call (SOS) is received, the longitude and latitude of the transmitting end are located to calculate the position of the transmitting end.

If the master is at a normal mode, the timer 17 generates a timing, and the schedule processing unit 19 transmits a timing generated by the timer 17 to the slave at a specific time, such that the slave knows the existence of the master, and a time check can be performed to the slave and the master as well.

If a pairing expires when the master and the slave are not connected, the master will use the random number generator 18 to generate a time slot in a channel through the function processing unit, and the schedule processing unit 19 controls the RF control unit 12 to control sending a link signal at an appropriate time for its receipt at other time slots. If a reply signal of the connection is received by the slave, the master and slave pairing and linking are completed.

If two masters have never been linked or paired, the first master uses the random number generator 18 to produce a time slot at the linked channel, and transmits the link signal according to the generated time slot. If the signal is received at other slots, there is a link signal of the second master, then the serial numbers (IDs) are compared. If the ID of the first master is higher, then the first master serves as the master and the second master serves as the slave (wherein the method of comparing IDs can be changed to a small ID for a master according to different systems.)

If a link reply of the second master is received when it is determined whether or not the first master has received a link reply signal from the second master, a link complete signal is transmitted to the second master. Similarly, the second master also uses the random number generator 18 to produce a time slot at the linked channel, and sends out a link signal according to the time slot. If a link signal from the first master is received, the serial numbers (IDs) are compared. The first master has a larger ID and serves as a master, and the second master serves as a slave. After the second master has transmitted the link reply signal, the second master receives a master link signals to complete the pairing.

After the foregoing allocation is completed, several communication positioning apparatuses can be connected and operated at a communication positioning mode with one apparatus serving as the master, and the remaining apparatuses serving as the slaves, and such apparatuses can be applied to calls or emergency calls (mountain climbing rescues) for a group (such as a car team or a mountain climbing team).

While the invention is described in by way of example and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A many-to-many crosslink communication positioning apparatus, for setting one of a plurality of communication positioning apparatus as a mater, and the remaining ones of the communication positioning apparatus as slaves through a cross allocation, and the communication positioning apparatus comprising:
a central processing unit (CPU);
a radio frequency circuit (RF circuit), electrically coupled to the CPU, for transmitting and receiving a signal of the master or slave;
a global positioning system circuit (GPS circuit), electrically coupled to the CPU, for receiving a satellite signal;
an electronic compass circuit, electrically coupled to the CPU, for providing an electronic compass position detection signal to the CPU;
wherein the CPU comprises:
a CPU kernel, for processing an arithmetic operation and executing and processing a program;
a RF control unit, electrically coupled to the RF circuit, for controlling a signal transmitted or received by the RF circuit;
a GPS control unit, electrically coupled to the GPS circuit, for controlling the GPS circuit;
an electronic compass control unit, electrically coupled to the electronic compass circuit, for controlling the electronic compass circuit;
a frequency hopping unit, electrically coupled to the RF control unit, for performing a frequency hopping when a received or transmitted data is interfered or the CPU calculates that a frequency hopping is needed;
a random number generator, electrically coupled to the CPU kernel, for generating a random number to the CPU;
a schedule processing unit, electrically coupled to the CPU kernel, for performing an electronic compass control schedule processing, a GPS control schedule processing, a RF control schedule processing and an external communication schedule processing in each time slot;
a data processing unit, electrically coupled to the CPU kernel and the schedule processing unit, for processing an electronic compass data, a GPS signal, a RF signal and an external instruction data;
a function processing unit, electrically coupled to the CPU kernel, the schedule processing unit and the data processing unit, for computing and processing a data link function, a search function, a call function, an emergency call function, a search emergency call function and a pairing function;
an external communication interface unit, electrically coupled to the RF control unit, the GPS control unit, the electronic compass control unit, the transmission power modulating unit and the schedule processing unit, for receiving an instruction and a replay outputted by an external hardware.

2. The apparatus of claim 1, wherein the CPU further comprises a timer electrically coupled to the CPU kernel for generating a timing for a use of the entire system, and all function of the apparatus use the timing generated by the timer as a basis.

3. The apparatus of claim 1, wherein the CPU further comprises a transmission power modulating unit electrically coupled to the RF control unit for adjusting the transmission power according to the distance between the master and the slave.

4. The apparatus of claim 1, wherein the external communication interface unit is provided for receiving an instruction and a reply including a pairing, a link, a data report, an emergency call, a GPS signal and an electronic compass signal outputted by an external hardware.

5. The apparatus of claim 1, wherein the external communication interface unit provides an electronic compass to the CPU kernel according to a different required GPS signal for the external communication interface unit installed on a different device.

6. The apparatus of claim 1, wherein when a plurality of communication positioning apparatuses are connected for comparing the serial number (ID) of each apparatus, and the apparatus with a larger serial number (ID) is a master, and the apparatus with a smaller serial number (ID) is a slave.

7. The apparatus of claim 6, wherein the apparatus with a small serial number (ID) is switched to serve as a master according to different requirements of different apparatuses.

8. The apparatus of claim 1, wherein the master jumps to search for an apparatus when the master is not at a time slot.

9. The apparatus of claim 1, wherein the apparatus search and monitor whether or not there is a new apparatus, when the slave is not at a time slot.

10. The apparatus of claim 1, wherein the master uses a random number generator to generate a time slot in a searched channel during a search, and search for a missing slave.

11. The apparatus of claim 1, wherein when the slave calls the master, and the master receives a slave call signal from the slave to calculate relative distance and positions of the master and the slave, and replies a signal to the slave to complete calling the master and slave.

12. The apparatus of claim 1, wherein the master enters into a frequency hopping mode, if the index of intensity of the signal received by the master is too small, or a data loss in the same time slot is too large, and then all channels are searched to check whether or not there is an available channel, and if there is an available channel, the frequency hopping signal is transmitted to notice all slave for the frequency hopping, so that the slave starts hopping the frequency.

13. The apparatus of claim 1, wherein the master receives data from the slave, and calculates the longitude and latitude and the index of intensity of the received signal to determine whether or not it is necessary to adjust the transmission power of the slave.

14. The apparatus of claim 1, wherein the master and the slave enter into an emergency call mode, and all functions being used are disabled.

15. The apparatus of claim 1, wherein the master selects to start searching whether or not there is an emergency call signal at normal mode, and after the emergency call signal is received, a longitude and a latitude of the transmitting end are located, and the position of the transmitting end is calculated.

16. The apparatus of claim 1, wherein if the master and the slave have never been linked or paired, the master will use a random number generator to generate a time slot in a channel through the function processing unit, and transmits a link signal through the RF circuit, and if a link reply signal of the slave is received, the slave pairing and link are completed.

17. The apparatus of claim 1, wherein if the master and another master have never been linked or paired, the two masters use the random number generator to generate a time slot each at a linked channel, and the link signal is transmitted according to the time slot, and when the two masters have received the signals transmitted from another master, the serial numbers (IDs) are compared, and if the ID of the first master is higher than the ID of the second master, then the first master serves as a master, and the second master serves as a slave.

18. The apparatus of claim 17, wherein the apparatus with a small serial number (ID) is switched to serve as a master according to different requirements of different apparatuses.
